(19) United States
(12) Patent Application Publication
(10) Pub. No.: US 2009/0182997 A1
(43) Pub. Date: Jul. 16, 2009

(54) SYSTEM AND METHOD FOR DETECTING

(75) Inventors: Clive Henry Gillard, Alton (GB); Daniel Luke Hooper, London (GB)

Correspondence Address: OBLON, SPIVAK, MCCLELLAND MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/877,257

(22) Filed: Oct. 23, 2007

(30) Foreign Application Priority Data
Oct. 23, 2006 (GB) 0621063.7

(51) Int. Cl. H04L 9/06; G06F 21/00

(52) U.S. Cl. 713/153; 726/26

(57) ABSTRACT

A system for recovering an estimate of a finger print code word from an un-authorised copy of content material includes a content packaging apparatus. The content packaging apparatus includes a secure content production device and a proxy generator. The secure content production device is operable to convert the content material into a content data file for distribution to a reproduction apparatus, the content data file including frames of the content material which are to be reproduced by a reproduction apparatus and to encrypt the content data file using a content encryption key to form a secure content data file for secure distribution to the reproduction apparatus. The proxy generator is operable to generate a proxy version of the content material representing a reduced quality version of the content material, the quality being reduced to discourage unauthorised copying of the content material and including the frames of the content material which are to be reproduced by the reproduction apparatus. The proxy generator is operable to record the proxy version of the content onto a carrying medium. The reproduction apparatus is operable to decrypt the secure content file to recover the content material, to introduce one or more finger print code words into the frames of the content to form a marked version of the content, and to reproduce the marked content. A detection device is operable to receive the carrying medium and to receive a suspected unauthorised copy of the marked content reproduced by the reproduction apparatus, and to reproduce the proxy version of the content from the carrying medium. The reproduced version of the proxy version of the content has the same frames of the content as produced by the reproduction of the content by the reproduction apparatus. The detection device is operable to recover an estimate of the one or more finger print code words by comparing the frames of the proxy version with the frames of the suspect version.

Embodiments of the present invention seek to provide an arrangement in which a proxy version of the content material can be generated and distributed to finger print code word detection devices to facilitate detection of the fingerprint code words and thus the payload provided in those fingerprint code words.

### FIELD OF THE INVENTION

The present invention relates to systems and methods for detecting a finger code word which is present in an un-authorised version of information material. Embodiments of the present invention find application to digital cinema, so that in one example the information material may be audio and/or video material.

### BACKGROUND OF THE INVENTION

Generally, a technique for embedding data in material to the effect that the embedded data is perceptible or imperceptible is referred to as watermarking. Code words are applied to copies of material items for the purpose of identifying the copy of the material item or for conveying data represented by the code words. In some applications, watermarking can provide, therefore, a facility for identifying a recipient of a particular copy of the material.

A process in which information is embedded in material for the purpose of identifying a specific copy of the material is referred to as finger printing. A code word, which identifies the material, is combined with the material in such a way that, as far as possible, the code word is imperceptible in the material. As such, if the material is copied or used in a way, which is inconsistent with the wishes of the owner, distributor or other rights holder of the material, the copy of the material can be identified from the code word, so that the right holder can take appropriate action. The code word is therefore used to convey a payload data word, which can be used to identify uniquely the copy of the material. In the following description and claims, the term “water mark” and “finger printing” may be used interchangeably, particularly in respect of the encoding and detection techniques disclosed.

In order to detect finger print code words in suspected un-authorised versions of material, some detectors require a copy of the original version of the material in order to subtract the original version from the suspected un-authorised version to recover an estimate of the finger print code words. However, the requirement for a copy of the original version of the material, can itself present a risk in that the copy of the original required by the detection device, may itself be copied.

### SUMMARY OF INVENTION

According to the present invention there is provided a system for recovering an estimate of a finger print code word from an un-authorised copy of content material. The system includes a content packaging apparatus, the content packaging apparatus including a secure content production device and a proxy generator. The secure content production device is operable to convert the content material into a content data file for distribution to a reproduction apparatus, the content data file including frames of the content material which are to be reproduced by a reproduction apparatus and to encrypt the content data file using a content encryption key to form a secure content data file for secure distribution to the reproduction apparatus. The proxy generator is operable to generate a proxy version of the content material representing a reduced quality version of the content material, the quality being reduced to discourage unauthorised copying of the content material and including the frames of the content material which are to be reproduced by the reproduction apparatus. The proxy generator is operable to record the proxy version of the content onto a carrying medium. The reproduction apparatus is operable to decrypt the secure content file to recover the content material, to introduce one or more finger print code words into the frames of the content to form a marked version of the content, and to reproduce the marked content. A detection device is operable to receive the carrying medium and to receive a suspected unauthorised copy of the marked content reproduced by the reproduction apparatus, and to reproduce the proxy version of the content from the carrying medium. The reproduced version of the proxy version of the content has the same frames of the content as produced by the reproduction of the content by the reproduction apparatus. The detection device is operable to recover an estimate of the one or more finger print code words by comparing the frames of the proxy version with the frames of the suspect version.

Embodiments of the present invention seek to provide an arrangement in which a proxy version of the content material can be generated and distributed to finger print code word detection devices to facilitate detection of the fingerprint code words and thus the payload provided in those fingerprint code words.

Detection devices can require a version of the original content material in order to detect finger print code words, which are present within a suspected un-authorised version of the content material. However, if a version of the original content material is required, there maybe a risk that the version of the content could itself be copied and distributed in an un-authorised way. As such, a detection device, must either be secure itself, or the detection device would itself be required to be within a secure trusted environment, for example within the premises and operated by a producer of the content material. This can be inflexible because production companies of content material such as audio/video content for digital cinema, would be required to perform the detection and evidence gathering to police un-authorised use themselves, whereas third party organisation may be better suited to such a task. Generating a proxy version of the content material to facilitate the detection of finger print code words, during or after the time of production of the content material, such as a digital cinema package, provides a facility for as many copies of the proxy version of the audio video content material to be made available as required, so that as many enterprises as possible can be engaged in the process of detecting un-authorised pirate copies of the material.

Embodiments of the present invention can therefore generate a proxy version of the audio/video content after the audio/video content material is packaged and encrypted for distribution.

Various further aspects and features of the present invention are defined in the appended claims.

### BRIEF DESCRIPTION OF THE DRAWINGS

Embodiments of the present invention will now be described with reference to the accompanying drawings where like parts are identified with the same alphanumeric reference numerals and in which:

FIG. 1 is a schematic block diagram of a digital cinema projection facility in which finger print code words are introduced at the time of reproduction of audio/video content;

FIG. 2 is a representation of finger print code words being written into frames of video content;

FIG. 3 is a simplified schematic block diagram of part of a detection device;

FIG. 4 is a schematic block diagram of a secure packaging apparatus according to an example embodiment of the present invention; and

FIG. 5 is a schematic block diagram of a detection device according to an example embodiment of the present invention.

### DESCRIPTION OF EXAMPLE EMBODIMENTS

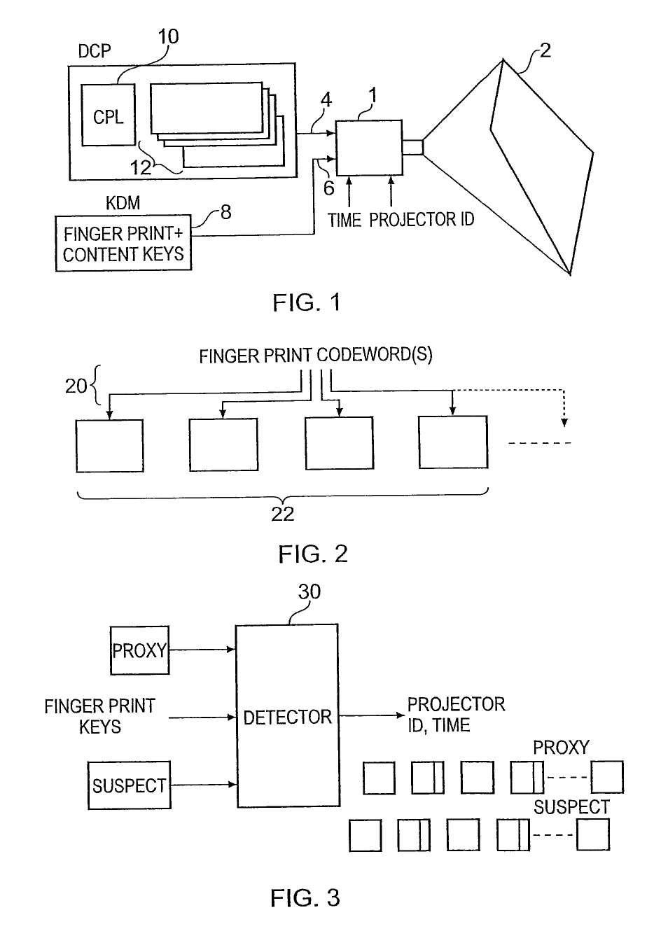

FIG. 1 provides an illustrative representation of a system in which a fingerprint code word or code words are introduced into a cinematic projection of audio and/or video material provided in for example a digital format. A data file known as a digital cinema projection file (DCP) is communicated to a digital cinema projector 1 for projection onto a display screen 2. The DCP file which includes both audio information, video information as well as data is received on a first input 4 of the digital cinema projector 1. To a second input 6 is provided a key data media (KDM) file 8 which includes keys for decrypting encrypted content data, which represent the audio/video information and keys which are used to encrypt digital fingerprint code words which are to be embedded into the audio and video information which is regenerated and projected onto the display screen 2 by the digital cinema projector 1. The DCP file includes a content play list CPL 10 as well as content data representing the audio/video information. The content data is provided in the form of a plurality of reels 12 each of which provides approximately 10 minutes of audio and/or video information when reproduced and is itself encrypted.

As indicated above, the KDM file 8 also includes the content encryption keys, which are used to decrypt the content data for reproducing the audio/video information for projection onto the display screen 2. Within the digital cinema projector 1 there is provided a secure unit to which the content encryption keys and the fingerprint encryption keys are provided as well as the digital content data. The secure unit is arranged in such a way that should the unit compromised in some way by breaking into the unit then the keys are immediately destroyed.

As described in our co-pending UK patent application number 0611128.0 a fingerprint code word is generated and encrypted from a payload data word which includes a time of projection of the digital cinema content and a ID of the projector. The pay load is encrypted and used to form digital fingerprint code words which are then embedded in each of the frames of the audio and/or video material as for example represented in FIG. 2.

In FIG. 2 the fingerprint code words represented by arrows 20 are embedded in each of the frames of the video material 22. Should an un-authorised copy of the cinema projection be produced then as described in our co-pending UK patent application the original fingerprint code words can be recovered decrypted and used to identify the source of the un-authorised copy by the projector ID as well as the time at which the illegal copy was made. Thus, a perpetrator of the un-authorised copy can be identified. To this end, the un-authorised copy of the audio/video material is applied to a detector 30 along with a proxy version of the digital cinema material as well as the fingerprinting keys, which were used to encrypt the payload data represented by the finger print code words. The detector 30 is then arranged to detect the fingerprint code words and to decrypt the fingerprint code words to recover the particular projector ID and the time at which the suspect version was generated as a result of the time being introduced by the digital cinema projector 1 into the projected version of the video.

The detection process performed by the detector 30 is as disclosed in our co-pending UK patent application 0611128.0 and will not be repeated here. However, what is pertinent to embodiments of the present invention is that in order to detect the fingerprint code word as performed by the detector 30 then a proxy version of the original video content is required in order to align the frames of the suspect image with the proxy version of the video in order to detect the fingerprint code words. The proxy version is required to be subtracted from the suspect video in order to facilitate detection of the fingerprint code words. However, to subtract the proxy version from the suspect version then the frames of the proxy version must be aligned to the suspect version. This process is known as registering.

Embodiments of the present invention can provide an arrangement in which a proxy version of the digital cinema audio/video material can be generated and distributed to detectors to facilitate detection of the fingerprint code words and thus the payload provided in those fingerprint code words. As will be appreciated by those acquainted with the production of audio and/or video material for digital cinema a production time for the audio/video and the cost of the production requires that revenue is recovered from the audio/video production as soon as the audio and/or video material content is finished. However, generating a proxy version of the audio/video material after the production of the DCP from the audio and/or video content material, introduces a relatively small amount of work after the DCP has been completed, compared to a requirement for providing a secure facility for the detection device. Furthermore, many copies of the proxy version of the audio video content material can be made available so that as many enterprises as possible can be engaged in the process of detecting un-authorised pirate copies of the material. As will be appreciated as far as possible, unencrypted versions of the audio/video content material should not exist until a point at which the audio and/or video content material is re-produced for sale or display in a cinema.

As will be appreciated a process of detecting a fingerprint code word and therefore a pay load which provides forensic evidence for identifying a perpetrator of a un-authorised copy could be performed within a secure environment as part of a production of the audio and/or video content. Again however, this would restrict the availability of facilities to detect a fingerprint code word in audio/video content. This is because providing a detector within a secure packaging or production facility, would restrict the availability of detectors to third party companies which could act to detect the source of un-authorised copies of audio/video content as part of a commercial service.

### Example System According to the Present Technique

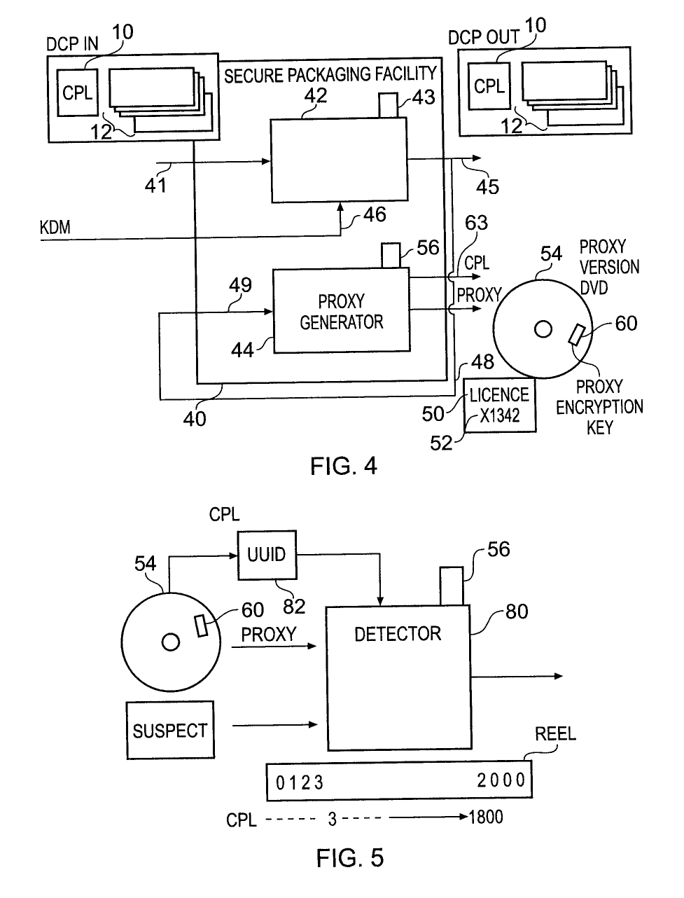

FIGS. 4 and 5 provide an illustration of an example system for distributing proxy versions of audio/video content material to third party companies for detecting and identifying the source of un-authorised copies of the audio-video content. In FIG. 4 a secure packaging facility 40 includes a secure content production unit 42 and a proxy generator 44. The secure production unit 42 receives the audio/video content in the form of a DCP (DCP IN) on an input 41 and forms a DCP for distribution (DCP OUT) on an output channel 45. The secure production unit 42 receives a KDM on an input channel 46, and decrypts the received DCP and re-encrypts the received DCP, using a session key provided on a secure delivery unit (dongle) 43 to form the output DCP. The output DCP includes the content encrypted as a plurality of reels 12 and a content play list 10 for use in reproducing the audio/video content for display at a digital cinema. The session key is distributed separately to the digital cinema to allow the DCP to be decrypted.

The DCP representing the audio/video content material is also fed from the output channel 45 to an input channel 49 of the proxy generator 44 which generates a proxy version of the audio/video content from the packaged DCP. The proxy generator 44 reproduces the audio/video content from the DCP by decrypting the DCP using the session key and generates a proxy version of the audio/video content. In one example the audio/video content, which may be represented as a Discrete Wavelet Transform is arranged to select a first order transform coefficients, which are used to re-produce the audio/video content in a reduced bandwidth version by forming an inverse Discrete Wavelet Transform. Thus, the proxy version of the audio/video content has a much lower spatial bandwidth to that of the original content. The proxy version is also black and white and includes a visible water mark as for example represented by an image frame 48 which includes visible watermark 50 over an image 52. A proxy version of the audio/video content is then recorded on a data carrier, such as for example a DVD 54. However, to prevent unauthorised copying and reproduction of this proxy version of the audio/video content the proxy version is encrypted before being recorded onto the DVD 54. The proxy version is encrypted with a proxy encryption key, which itself is encrypted using a delivery key, which maybe for example a symmetric key provided, for example on a “dongle” unit 56, which is connected to the proxy generator 44. Thus the proxy encryption key is also encrypted with the delivery key provided on the dongle unit 56 and the encrypted proxy key is recorded on the DVD 54 in an area as shown as 60.

Thus as shown in FIG. 4 within the secure packaging facility 40 a proxy version of the audio/video content material is generated just after the DCP is packaged for distribution. Since the proxy version is produced within this secure packaging facility and is encrypted, the likelihood of successfully reproducing the audio/video content in a useful form is substantially reduced. Furthermore, the visual watermark 50 also dissuades use of this proxy version for commercial gain. In addition, since the proxy version is produced after the audio/video content material is transformed into the encrypted content data (DCP), and this represents a relatively small amount of extra processing following the production of a DCP, an amount of extra effort required by the production company is relatively small as compared for example to having to perform the detection of fingerprints to identify the source of an un-authorised version of the audio/video content.

In order to facilitate the detection process by reproducing the audio/video content in exactly the form in which is would be produced by a digital cinema, the content play list CPL is also copied onto the proxy version DVD 54 as shown by an arrow 62.

FIG. 5 provides an example illustration of a detector which reproduces the audio/video proxy from the disk 54 for registration with an un-authorised version in order to detect the fingerprint codeword and recover the pay load data. A detector 18 receives the dongle unit 56 on which is recorded the private delivery key, which can be used to decrypt the content proxy encryption key stored in an area 60 on the DVD 54. Thus using the delivery key the proxy content encryption key 60 can be recovered from the DVD 54 and the reproduced encrypted proxy version can be decrypted for use in the detection process.

Also reproduced from the DVD 54 is the content play list CPL, which generates for each of the reels 12 provided in the DCP a list of Universal Unique Identifiers (UUID) 82, which can then be used by the detector to re-produce exactly the version of the audio/video content which was re-produced in the digital cinema. For example as shown in FIG. 5 a total list of frames between 0 and 2000 in a reel 84 may be provided with the proxy version but in fact according to the CPL only frames 3 to 1800 are to be reproduced from the reel 84. Frames 3 to 1800 are therefore recorded in the UUID list 82, which is supplied to the detector which then reproduces frames 3 to 1800 to form the proxy version within the detector 80. Thereafter registration of the proxy version with un-authorised version can take place, subtracting the proxy version from the un-authorised version in order to facilitate the detection of the fingerprint pay load providing the time and the projector ID for providing forensic evidence of the source of the un-authorised copy of the audio/video content.

Also included on the proxy version DVD 54, in some examples maybe the proxy files and the fingerprint key, use to encrypt the produce the finger print code word, which are encrypted with a common session key. The common session key which is also encrypted using for example an asymmetric key such as provided by the RSA algorithm. The proxy version DVD 54 may also include:

1. An identifier of the content play list (CPL ID), which provides a check, which can allow import of further Proxy Packages into a detector.

2. Reel Annotation Text. (e.g. Movie Title).

3. In addition to information about each reel, a list of reels is exported for which proxy is being sent.

4. A Projector/Software version number.

5. A CRC or hash to guarantee data integrity, although this is for software stability reasons rather than security.

6. A Flag to indicate whether the session key has been encrypted using some function of the target application's serial number. This is an optional feature.

The secure delivery device or “dongle” is a commercially available device such as for example disclosed at:

http://www.safenet-inc.com/products/tokens/ikey2032.asp

This example is referred to as an “ikey”, which provides a compact hardware solution for authentication and digital identity management. While offering similar functionality to a smartcard, iKey packs two-factor authentication, encryption key management, and digital signing functionality into a small, secure package that includes an integrated USB port to eliminate a need for a separate reader device. The iKey FIPS 140-1, Level 2 validated hardware, onboard key generation, key storage, encryption, and digital signing capabilities add highly-assured security to user login, email encryption, disk encryption, VPN authentication, and other secure client applications.

Various further aspects and features of the present invention are defined in the appended Claims.

Various modifications may be made to the embodiments herein before described without departing from the scope of the present invention. In particular although a particular format for the digital cinema audio/video content has been represented and which may be consistent with the SMPTE group digital cinema 28 other forms of delivering audio/video content to digital cinema can also be used. Furthermore the detection of the source of pirate or illegal obtained versions of audio/video content is not limited to digital cinema but can find application when any similar version of audio/video content is reproduced and copies in the usual way.

1. A system for recovering an estimate of a finger print code word from an un-authorised copy of content material, the system comprising
a content packaging apparatus including a secure content production device and a proxy generator, the secure content production device being operable
to convert the content material into a content data file for distribution to a reproduction apparatus, the content data file including frames of the content material which are to be reproduced by a reproduction apparatus,
to encrypt the content data file using a content encryption key to form a secure content data file for secure distribution to the reproduction apparatus, and
the proxy generator is operable
to generate a proxy version of the content material representing a reduced quality version of the content material, the quality being reduced to discourage unauthorised copying of the content material and including the frames of the content material which are to be reproduced by the reproduction apparatus, and
to record the proxy version of the content onto a carrying medium, wherein the reproduction apparatus is operable
to decrypt the secure content file to recover the content material,
to introduce one or more finger print code words into the frames of the content to form a marked version of the content, and to reproduce the marked content, and
a detection device is operable
to receive the carrying medium and to receive a suspected unauthorised copy of the marked content reproduced by the reproduction apparatus,
to reproduce the proxy version of the content from the carrying medium, the reproduced version providing of the proxy version of the content having the same frames of the content as produced by the reproduction of the content by the reproduction apparatus, and to recover an estimate of the one or more finger print code words by comparing the frames of the proxy version with the frames of the suspect version.

2. A system as claimed in claim 1, wherein the content data file produced by the secure content production device includes a content play file and one or more reels, each of which is representative of portions of the content material, the portions including a plurality of the frames of the content material, the content play file indicating for each of the one or more portions of content the frames of the portion which are to be reproduced, and the proxy generator is operable to receive the content play file, and to record the content play file on the carrying medium with the proxy version of the content material.

3. A system as claimed in claim 1, wherein the proxy generator is operable to encrypt the proxy version of the content using a proxy encryption key, and the detection device is operable to decrypt the encrypted proxy version of the content using the proxy encryption key to reproduce the proxy version of the content.

4. A system as claimed in claim 3, wherein the content play file is encrypted.

5. A system as claimed in claim 3, wherein the proxy encryption key is encrypted using a secure delivery key provided by a delivery device provided to the proxy generator when connected thereto, and the proxy generator is operable to record the encrypted proxy encryption key on the carrying medium, the detection device being arranged to receive the secure delivery key from the delivery device to decrypt the proxy encryption key for decrypting the proxy version.

6. A system as claimed in claim 1, wherein the proxy generator is operable to introduce a perceivable impairment into the proxy version of the content material.

7. A system as claimed in claim 1, wherein the visible impairment is a perceivable or visible watermark.

8. A content packaging apparatus, including a secure content production device and a proxy generator,
the secure content production device being operable
to convert the content material into a content data file for distribution to a reproduction apparatus, the content data file including frames of the content material which are to be reproduced by a reproduction apparatus,
to encrypt the content data file using a content encryption key to form a secure content data file for secure distribution to the reproduction apparatus, and
the proxy generator is operable
to generate a proxy version of the content material representing a reduced quality version of the content material, the quality being reduced to discourage unauthorised copying of the content material and including the frames of the content material which are to be reproduced by the reproduction apparatus, and
to record the proxy version of the content onto a carrying medium.

9. A content packaging apparatus as claimed in claim 8, wherein the proxy generator is operable to encrypt the content using a proxy encryption key, and to encrypt the proxy encryption key using a secure delivery key, and to record the encrypted proxy encryption key on the carrying medium.

10. A content packaging apparatus as claimed in claim 9, wherein the secure delivery key is received from a delivery device.

11. A content packaging apparatus as claimed in claim 8, wherein the content data file produced by the secure content production device includes a content play file and one or more reels, each reel being representative of portions of the content material, the portions including a plurality of the frames of the content material, the content play file indicating for each of the one or more portions of content the frames of the portion which are to be reproduced, and the proxy generator is operable to receive the content play file, and to record the content play file on the carrying medium with the proxy version of the content material.

12. A content packaging apparatus as claimed in claim 8, wherein the carrying medium is provided to a third party under license for detecting un-authorised copies of the content material.

13. A method for recovering an estimate of a finger print code word from an un-authorised copy of content material, the method comprising converting the content material into a content data file for distribution to a reproduction apparatus, the content data file including frames of the content material which are to be reproduced by a reproduction apparatus,
encrypting the content data file using a content encryption key to form a secure content data file for secure distribution to the reproduction apparatus, and
generating a proxy version of the content material representing a reduced quality version of the content material, the quality being reduced to discourage unauthorised copying of the content material and including the frames of the content material which are to be reproduced by the reproduction apparatus,
recording the proxy version of the content onto a carrying medium,
decrypting the secure content file to recover the content material,
introducing one or more finger print code words into the frames of the content to form a marked version of the content,
reproducing the marked content,
receiving the carrying medium,
receiving a suspected unauthorised copy of the marked content reproduced,
reproducing the proxy version of the content from the carrying medium, the reproduced version providing the proxy version of the content having the same frames of the content as produced by the reproduction of the content, and
recovering an estimate of the one or more finger print code words by comparing the frames of the proxy version with the frames of the suspect version.

14. A carrying medium for use with the system of claim 1, the carrying medium having recorded thereon a proxy version of the content material representing a reduced quality version of content material, the quality being reduced to discourage unauthorised copying of the content material and including the frames of the content material which are to be reproduced by the reproduction apparatus, and
a content play file indicating for each of one or more portions of content, which include a plurality of frames, the frames of the portion which are to be reproduced.

15. A system as claimed in claim 1, wherein the content material is representative of audio/video content and the reproduction apparatus includes a projector for projecting the video content in a digital cinema.

16. An apparatus for recovering an estimate of a finger print code word from an un-authorised copy of content material, the apparatus comprising
means for converting the content material into a content data file for distribution to a reproduction apparatus, the content data file including frames of the content material which are to be reproduced by a reproduction apparatus,
means for encrypting the content data file using a content encryption key to form a secure content data file for secure distribution to the reproduction apparatus, and
means for generating a proxy version of the content material representing a reduced quality version of the content material, the quality being reduced to discourage unauthorised copying of the content material and including the frames of the content material which are to be reproduced by the reproduction apparatus,
means for recording the proxy version of the content onto a carrying medium,
means for decrypting the secure content file to recover the content material,
means for introducing one or more finger print code words into the frames of the content to form a marked version of the content,
means for reproducing the marked content,
means for receiving the carrying medium,
means for receiving a suspected unauthorised copy of the marked content reproduced,
means for reproducing the proxy version of the content from the carrying medium, the reproduced version providing the proxy version of the content having the same frames of the content as produced by the reproduction of the content, and
means for recovering an estimate of the one or more finger print code words by comparing the frames of the proxy version with the frames of the suspect version.
